(19) United States
(12) Patent Application Publication
(10) Pub. No.: US 2012/0128364 A1
(43) Pub. Date: May 24, 2012

(54) Fiber Optic Distributed Input/Output System for Wind Turbine

(75) Inventor: Kevin L. Cousineau, Ridgecrest, CA (US)

(73) Assignee: CLIPPER WINDPOWER, LLC, Carpinteria, CA (US)

(21) Appl. No.: 13/319,719

(22) PCT Filed: Aug. 6, 2009
(86) PCT No.: PCT/IB2009/006504

§ 371 Date: Feb. 7, 2012

Related U.S. Application Data
(60) Provisional application No. 61/216,102, filed on May 11, 2009.

(51) Int. Cl. H04B 10/12

(52) U.S. Cl. 398/110

(57) ABSTRACT

An industrial control system for use in power generating plants, manufacturing plants, oil and gas processing plants, utility sub-stations, utility grid switching yards, and wind or fluid-flow turbine generating systems. A master controller such as a master control unit or turbine control unit (MCU or TCU) printed circuit board (PCB) is located in an enclosure. A plurality of input/output I/O subsystems is located at a remote points-of-control for the remote I/O subsystems. A plurality of serial analog, digital, or frequency input/output fiber optic communication ports is located at the master controller printed circuit board, one port for each of the I/O subsystems. Fiber-optic cables connect the fiber optic communication ports on the master controller printed circuit board to fiber optic communication ports on the I/O subsystems. Means are provided at the master controller to distribute serialized I/O signals to the remote I/O subsystems over the fiber-optic cables.

### FIELD OF THE INVENTION

The present invention relates to embedded industrial control systems such as those used within manufacturing plants, power generation stations, utility sub-stations or electrical power switching stations, oil and gas processing plants, and fluid-flow turbine installations such as wind and water turbine generators and more particularly to a method and apparatus of communicating between distributed sensors and other components located throughout these control systems by fiber optics.

### BACKGROUND OF THE INVENTION

Many industrial control systems installations such as wind and waterpower installations are unique in that sensors and other components are distributed throughout the installation over large distances. For example, on a wind turbine, a master controller called a master control unit or turbine control unit (MCU or TCU) which includes a microprocessor or micro-controller, may be installed at the base of a very tall tower, whereas sensors for monitoring the operation of the turbine generators are located up tower in the nacelle, which houses the generators.

These control units (MCU or TCU's) may have as many as 300 or more input/output (I/O) devices and sensors connected to them. For example, in the case of a wind turbine, wind speed, wind direction, external temperature, yaw, rotor blade pitch, vibration detection on the transmission, generator and shaft bearings, grid status, temperature of the nacelle, coolant, transmission and generator. These sensors provide information to the turbine control unit or master control unit and identify conditions that might require control or shutdown. Shutdown conditions include (1) grid loss (2) excessive vibration, a failed gear box, a failed generator, a cracked rotor blade, turbulence effects, etc. (3) excessive temperature in the generator, gear box, nacelle air, etc. (4) excessive yaw.

Currently, parallel copper wires are strung from each sensor to the turbine control unit (TCU). Copper wire is very expensive and the cost to install and maintaining so many parallel wires is expensive.

It is therefore an object of the invention to provide an advanced control system which can be maintained more easily and which is more flexible and open-ended while being cheaper with respect to installation and maintenance.

### SUMMARY OF THE INVENTION

Briefly, the invention comprises an apparatus and method of distributing analog, digital and frequency inputs and outputs from a master controller to the areas under control either within the enclosure of the master controller or remotely elsewhere within a remotely installed enclosure.

Communication to these digital input and output functions is via a pair of fiber optic cables allowing the master controller to present multiple outputs in a serial fashion over a pair of fiber optic cables.

In accordance with an aspect of the invention, instead of multi-pin parallel digital, analog and frequency input and output connectors on the master controller board (MCU or TCU), pairs of fiber optic serial ports per control function are used; i.e., one pair for digital inputs, one pair for digital output, one pair for analog inputs, etc. Additionally, one pair of fiber optic communication ports may be used for all signals and remote boards or in other combinations where the digital inputs and outputs are connected using one set of fiber communication pairs, and the analog inputs and outputs on another, as an example.

These serialized I/O signals are distributed to remote I/O boards located where they are needed, (at the point-of-control), either within the master controller enclosure or in remotely located enclosures.

The system according to the invention collects data from remote sensors with small remote data acquisition boards and then connects all of these boards on a simple fiber optic serial loop to the central computer for processing. A series of simple microprocessor boards (remote I/O boards such at the RYO, DIN, or even an ANA) are therefore used that are designed to collect digital and analog data and convert it to a serial data stream that in turn is converted to an optical data stream. Each of these fiber data outputs and inputs (transmit and receive) are connected together in a series “daisy chain” loop for communication to a central control computer (the Turbine Control Unit or TCU). Therefore, the use of a system of the invention is a method of distributing the I/O requirements of the central computer to remote fiber linked I/O boards. Additionally, depending upon the number of master controller fiber ports used, both daisy chain and multi-drop connections may be used. If there are four remote boards, they may be connected in a daisy chain to a single pair of fiber cables or they may be connected in a multi-drop fashion using four individual pairs of fiber optic communication cables. Finally, a combination of both of these connection methods is possible also.

The system of the invention may use ordinary copper powered and copper communicated sensors and gather these in parallel to fiber serial converter—i.e., a remote I/O module (RYO, or DIN or ANA) that collects the data and converts this data to a fiber serial format for communication to a central computer. The I/O modules can be placed near the source of the signals and gather these signals into a single fiber optic communication link to a central computer. The I/O requirements of the central computer are distributed to remote locations via fiber optic communications links and thereby reduce the copper wires and improve the noise immunity.

The invention provides means for distributing the I/O for control systems and providing a secure method of communication between I/O boards and a master controller (MCU or TCU), where very large numbers of remotely distributed I/O boards and sensors can be accommodated without the extensive use of copper wires. The invention has the advantage that it reduces copper wire between relays, contactors, solenoids and other digitally switched devices and the master controller. Since induced noise within control wiring is directly proportional to the length of these wires and the strength of the interference, reducing the length of these wires reduces the induced interference and the overall susceptibility of these circuits to Electro Magnetic Interference (EMI).

According to the invention, a serial link between sub-system communication modules (RYO, DIN and even Analog Boards) and a Master Controller is used. The Master Controller may control the access and the small sub-system boards do not have equal access to the communication system. In such a setup the sub-systems only communicate data when they are addressed or are repeating the “loop” message. The protocol used in the communication system is “half duplex”, which according to the invention may be less than 1 MBit/s and most of the time on the order of 50 to 100 kBits/s.

The invention has the further advantage that it enables the master controller to be more easily expandable to meet future and changing needs for new designs.

According to the invention there are means of communicating between the remote distributed I/O boards and the master control system (MCU or TCU), which allows for easy I/O installation and increased I/O device accommodation to facilitate maintenance, trouble-shooting, repair and upgrading of complex wind power installations. The invention has the advantage that it reduces the size of the master controller enclosure by removal of some sub-systems to remote enclosures located near their respective control devices.

The invention has the further advantage that it provides better electrical isolation between controlled devices and the master controller board. Since communication between all of these remote I/O boards and the master controller is in the form of optical fibers and optical signalling, interference from electro-magnetic or magnetic fields is eliminated.

Additionally the invention offers the ability to locate a very large number of I/O boards where they are needed such that the length of connections between these I/O boards and the I/O functions themselves will be short when compared to running these same wires all the way back to the master controller (MCU or TCU).

The value of invention for a wind power turbine control unit (TCU) is that it allows for easy installation and repair while simultaneously allowing for a large number of input/output (I/O) devices characteristic of modern wind power and industrial control installations, with I/O counts exceeding several thousand are possible.

### BRIEF DESCRIPTION OF THE DRAWINGS

FIG. 1 shows a variable-speed wind-turbine generator system in which the invention is embodied;

FIG. 2 illustrates a prior art embedded master or turbine control system, (MCU or TCU) printed circuit board, which handles multiple Digital, Analog and Frequency inputs and outputs (I/O), along with serial ports for interface with user and remote monitoring systems. Each of these inputs and outputs are connected directly to this board via multi-pin connectors noted on the drawing;

FIG. 3 illustrates an embedded master or turbine control unit (MCU or TCU) printed circuit board of the present invention, which is designed to interface with remote digital, analog and frequency I/O boards via fiber optic serial communication. Each Fiber Optic transmitter and receiver has its own individual connector with many standard types available. For operation with Multi-Mode fibers the “ST” type connector is usually preferred. Each different type of I/O has its own communication port, so there is one port (two fiber cables, one pair with one for transmit and the other for receive) for the Digital Inputs, one port for Digital Outputs, one for Analog Inputs, etc.; and

FIG. 4 describes how the circuit board shown in FIG. 3 interfaces with its remote distributed I/O boards and other Fiber Serial devices such as individual sensors.

### DETAILED DESCRIPTION OF THE INVENTION

The current method of handling digital, analog and frequency data, both inputs and outputs, from an embedded, Programmable Logic Computer or Personal Computer is to have all of these signals arrive at that control unit in parallel where they terminate in some form of multi-pin connectors and/or terminal blocks. As control systems grow in I/O requirements, this method requires more and more copper wiring between the actual sensor and system and the control system itself. By serializing these digital, analog and frequency inputs and outputs in fiber optic communication loops, these signals can be distributed to the area where they are needed, thereby reducing the cabling cost associated with prior methods of control. Additionally, this allows the controller board to be expandable to a large number of I/O devices with ease, by simply adding more remote I/O boards to the fiber optic communication loop. Further, this method places the control I/O near the source and lowers the length of the copper inter-connections. Since the amount of electro-magnetic interference (EMI) and induced transient voltages are directly proportional to the length of the connection cable and the strength of the interference field, decreasing the length of these connections reduces the susceptibility of these circuits to EMI and induced transient voltages.

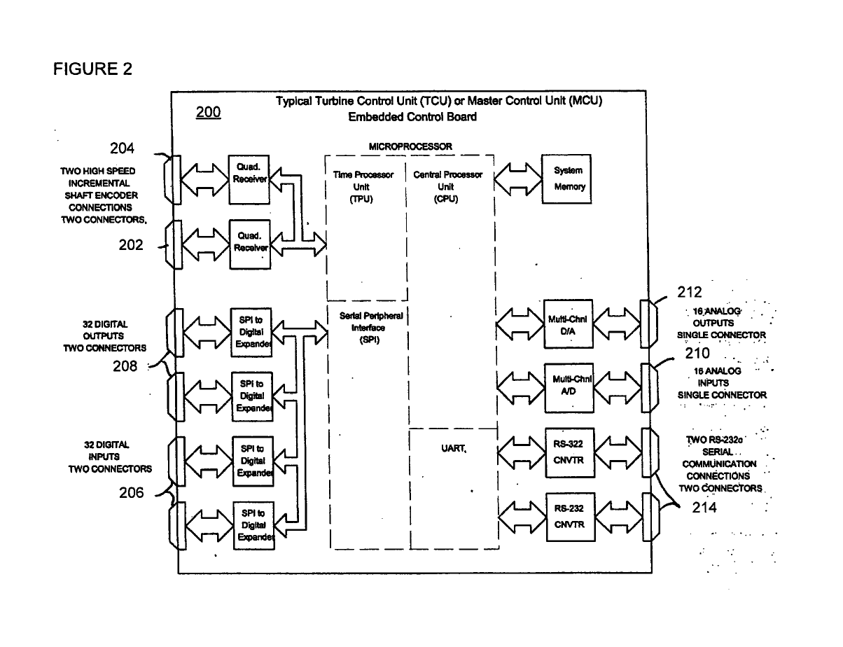

In the case of a Digital Input, at least two wires are required for each input. In FIG. 2 there are 16 digital inputs per connector, which in accordance with the present invention are replaced by a single pair of Fiber Cables. The trade-off is not only cost effective, but there is a great improvement in EMI and Induced Transient Voltage protection.

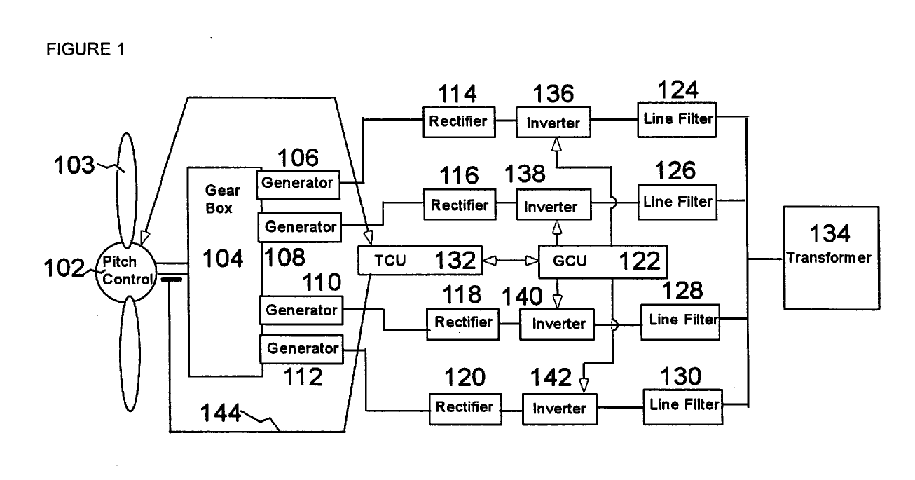

An example of a variable-speed wind-turbine generator system in which the invention could be embodied is shown in FIG. 1. There are six basic components of the system:

(1) a turbine drive train including a rotor hub mounted pitch servo system or PCU 102, blade rotor 103, distributed generation gearbox 104 and four permanent magnet generators 106, 108, 110, 112;
(2) generator rectifier units 114, 116, 118, 120;
(3) a control system comprising a generator control unit (GCU) 122 and a turbine control unit (TCU) 132;
(4) four independent inverters, 136, 138, 140, and 142;
(5) individual line filters for each converter, 124, 126, 128, 130; and
(6) a pad-mount transformer, 134.

Additional inputs to the turbine control unit 132 shown in FIG. 1 are a sensor 144 for measuring turbine speed on the low speed shaft, other distributed sensor inputs 145, sensors at the yaw system 180 and a SCADA system 179. The logic block 179 identifies a Supervisory Control and Data Acquisition (SCADA) system, which is a computer system for monitoring and controlling different aspects of the wind turbine installation.

The turbine comprises one or more rotor blades 103 connected to a shaft via a rotor hub mounted pitch control unit (PCU) 102, which is powered through slip rings. The pitch system utilizes a servo drive located in the wind turbine's hub. The hub is mechanically connected to the turbine main-shaft, which transmits the turbine's torque. The turbine shaft is coupled via a gearbox 104 and some suitable coupling device to four permanent magnet or wound field synchronous generators 106, 108, 110, 112. The generator electrical output is connected to the rectifiers, 114, 116, 118, and 120, which convert the electrical power to DC voltage and current. The DC power is then transmitted to the inverters, 136, 138, 140, and 142. The inverters regulate the DC current and by doing so, the generator torque is controlled. The inverter regulates this DC current by synchronizing to the grid and by supplying unity power factor current into the grid system. A generator-control unit (GCU) 122 controls each of the inverters. The GCU 122 takes inputs such as grid voltage, DC bus voltage, grid current, and commands such as torque level from a Turbine Control unit (TCU) 132. These commands are converted into signals which tell switching devices in an inverter when to turn on and off. These switches are controlled in such a way as to maintain regulated DC current. Line filters, 124, 126, 128, 130 are then used to reduce any harmonics that may have been generated by the inverter before passing power to a pad-mount transformer 134.

The TCU 132 receives sensor information 145, such as turbine speed, blade pitch angle, tower acceleration (vibration), nacelle acceleration (nacelle vibration), wind speed, wind direction, wind turbulence, nacelle position, AC line parameters, DC bus voltage, generator voltage, power output, and other fault related sensors. The TCU 132 has control of the two principle actuators on the turbine: the generators via the GCU 122, and the pitch control unit (PCU) 178. The TCU 132 performs a complicated, coordinated control function for both of these elements, and does so in a way, which maximizes the energy capture of the turbine while minimizing the machine's mechanical loads. The TCU 132 also controls the yaw system 180 to keep the turbine always pointed into the wind. The TCU 132 is also in communication with the turbine's SCADA system 179 in order to provide and receive sensor and status information. The logic block 179 identifies a Supervisory Control And Data Acquisition (SCADA) system, which is a computer system monitoring and controlling a process.

Refer to FIG. 2, which illustrates a prior art printed circuit board enclosure. This board 200, receives multiple digital, analog, and frequency inputs and outputs in parallel into individual multi-pin connectors. Two high-speed quadrature (incremental shaft encoders for shaft position and rotational speed sensing) are connected to two individual connectors 202, 204. 32 Digital Inputs are connected using two 16-channel connectors 206. 32 Digital Outputs are connected using two 16-channel connectors 208. 16 Analog Inputs are handled with a single 16-channel connector 210 and 16 Analog Outputs are handled with a single 16-channel connector 212. Finally, two serial ports 214 are used to provide interface with a user terminal for local human interface and monitoring and a SCADA system for remote human interface and monitoring.

The microprocessor or microcontroller is shown on the board 200 with a standard set of features including the Central Processing Unit or CPU, and a Universal Asynchronous Receiver Transmitter (UART) used for generating standard serial communication data. The output of the UART drives two RS-232C converters which convert the UART logic level output to RS-232C signal levels for interface with standard communication equipment such as Lap Top or Personal Computers or remote SCADA systems.

Other features of the Microprocessor include a Serial Peripheral Interface or SPI which is an on board, high speed, synchronous serial bit interface for connection and interface with peripheral devices such as the “SPI to Digital Expander” chips shown in FIG. 2. These convert the SPI serial signals to digital inputs or outputs. Finally the Time Processor Unit or TPU is a feature of the microprocessor which allows for high speed frequency counting, timing, pulse width measurement or generation, and other edge triggered signaling. In the case of the embedded controller it is used to interface with the quadrature signals to determine the position, speed and direction of a rotating shaft.

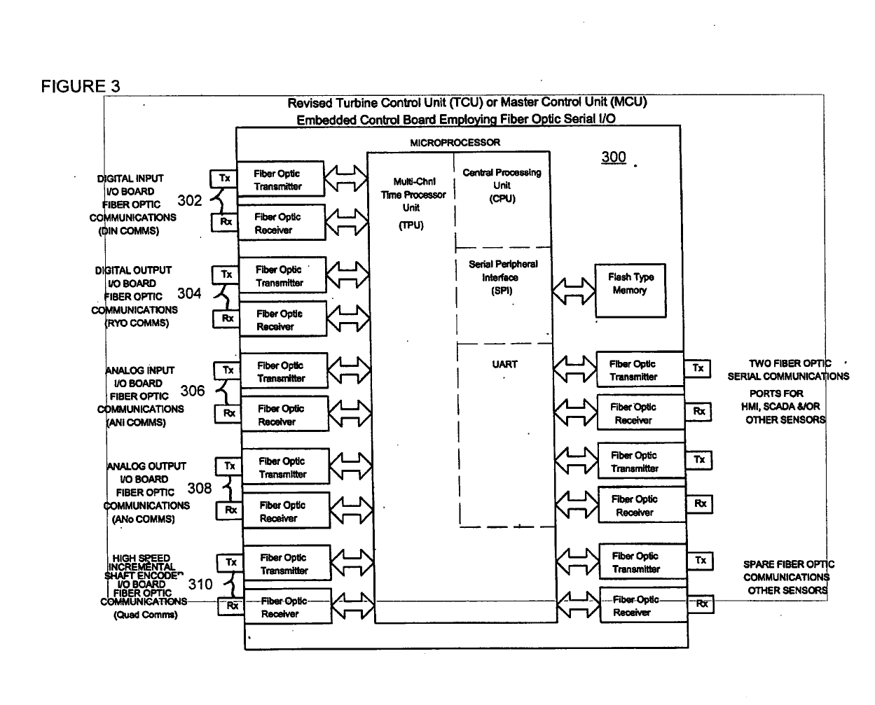

Refer to FIG. 3, which illustrates a printed circuit board 300 of the present invention. Here each of the connectors used in FIG. 2 to handle multiple digital and analog I/O signals are replaced by a series of fiber optic transmitters and receivers. Each different type of I/O has its own communication port, so there is one port (two fiber cables, one pair with one Tx for transmit and the other Rx for receive) for the Digital Inputs, one port for Digital Outputs, one for Analog Inputs, etc. The microprocessor contains the same type of features found on the microprocessor shown in FIG. 2, but used differently. Here the Time Processor Unit or TPU is used like a UART to provide multiple serial ports for conversion to fiber as shown. The UART is still used for serial data and for the same type of serial data only this time it is converted to a fiber serial output instead of the copper RS-232C shown in FIG. 2. Finally, the SPI port is used only for extra memory and data storage and is no longer used for digital I/O since there are no pure copper digital I/O ports on the board, freeing up this feature for other uses.

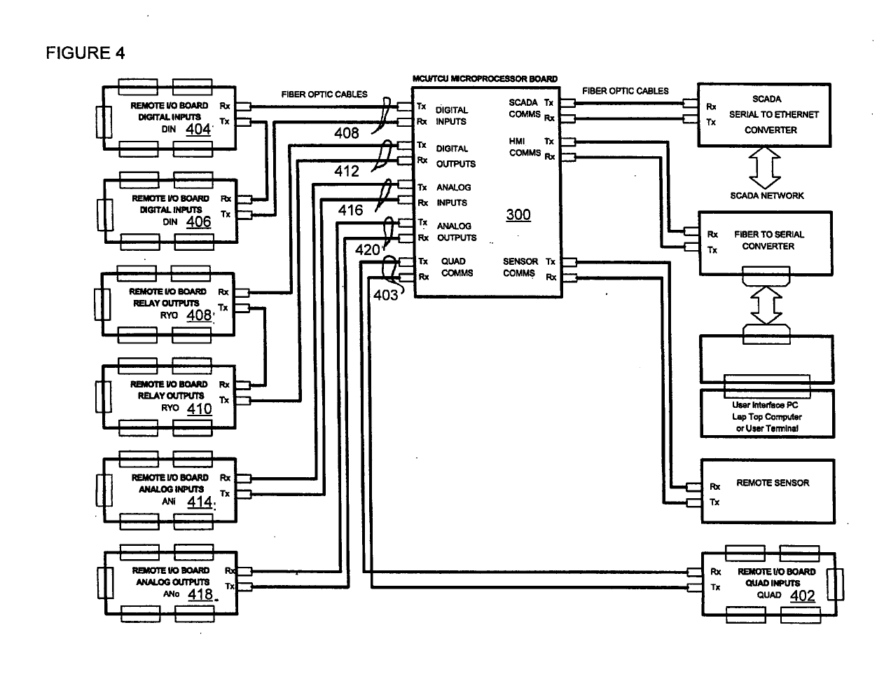

Refer to FIG. 4, which shows how the embedded microprocessor printed circuit board 300 is used within an overall control system and how the I/O is connected to this board from distributed and remote I/O boards. As shown, each individual function of the Microprocessor control board 300 has its own remote interface I/O board. For the high-speed-quadrature counters a single remote I/O board 402 is used providing two signals to the microprocessor board (MCU or TCU) via a single pair of fiber cables 403. For the digital inputs, two individual remote I/O boards 404, 406 are used each providing 16 digital inputs and connected to the microprocessor board via a single pair of fiber cables 408. These two boards are connected together and operate with “half duplex” operation such that they only respond when addressed but can receive global commands from the MCU/TCU microprocessor board simultaneously.

For the digital outputs, two individual remote I/O boards 408, 410 are used each providing 16 digital outputs and connected to the microprocessor board via a single pair of fiber cables 412. These two boards are connected together and operate with “half duplex” operation such that they only respond when addressed but can receive global commands from the MCU/TCU microprocessor board simultaneously.

For the analog inputs, one remote I/O board 414 is used providing 16 digital inputs and connected to the microprocessor board via a single pair of fiber cables 416. The board 414 operates with “half duplex” operation such that it only responds when addressed but can receive global commands from the MCU/TCU microprocessor board.

For the analog outputs, one remote I/O board 418 is used providing 16 digital outputs and connected to the microprocessor board via a single pair of fiber cables 420. The board 418 operates with “half duplex” operation such that it only responds when addressed but can receive global commands from the MCU/TCU microprocessor board.

Although each of these remote I/O boards contains 16 channels, there is no reason why this could not be more or less then 16 depending upon the application and requirements. A board with 64 channels of digital inputs and outputs may be used or a single board with only 8 analog inputs may be used also. The number is only limited by the processing requirements of the remote boards processor and the necessity of system I/O requirements for that particular application.

FIG. 4 illustrates how remote I/O boards can be distributed within the wind turbine or control plant at distances up to 1 or 2 kilometers for standard multi-mode devices. Most applications will require less than 100 meters and the majority on the order of ten's of meters only. However, the same advantages are obtained, less copper wire, more direct and short connections to the sensors and reduced EMI and induced transient voltage surges. In addition the microprocessor MCU/TCU board is fully isolated from the sensors themselves with the exception of any shared power supply. Power supplies can be isolated with ease using simple transformers for their AC power inputs. Such isolation prevents damage from transient voltages and assures proper operation in the noisy control environment of a wind turbine or other industrial application.

Additionally, each of the I/O boards is “smart” and can communicate any problems with their own sub-systems to the microprocessor MCU/TCU board. This gives operators and a remote system a better indication of problems and helps pinpoint areas in need of troubleshooting.

Finally, considering that the systems shown in FIGS. 2, 3 and 4 employ the same number of I/O—98, it is apparent that the system shown in FIG. 4 has far less copper wire to deal with because the connections are so much shorter when they are terminated remotely than when they are terminated at the master controller (MCU/TCU) board as shown in FIG. 2.

Each remote I/O board contains some type of terminals or connectors for individual sensor and signal interfaces. These boards contain an 8-bit processor, which receives this data and communicates it to a pair of fiber optic cables for connection to the master controller (microprocessor MCU/TCU board shown in FIG. 3).

It will be understood by those skilled in the art that the industrial control system described herein may be used in the following installations: a power generating plant, a manufacturing plant, an oil and gas processing plant, a utility sub-station, a utility grid switching yard, and a wind or fluid-flow turbine generating system.

1. An industrial control system for use in an installation comprising:
a master controller;
a plurality of input/output I/O subsystems distributed throughout the installation and located remotely from said master controller designed to collect digital or analog data and convert it to an optical data stream, the I/O subsystems each comprising at least one interface for coupling sensors via an electrical connection to the I/O subsystems;
a plurality of fiber optic communication ports at said I/O subsystems, and
a plurality of fiber optic communication ports at said master controller, each of said I/O subsystems being coupled to one port via fiber-optic cables connecting said fiber optic communication ports on said master controller with said fiber optic communication ports at said I/O subsystems.

2. The industrial control system of claim 1 wherein said master controller is a printed circuit board (PCB) located in its own enclosure.

3. The industrial control system of claim 1 wherein said I/O subsystems comprise a plurality of digital, analog and frequency input/output I/O subsystems distributed throughout the installation and located remotely from said master controller.

4. The industrial control system of claim 1, wherein said plurality of fiber optic communication ports at said master controller comprise a plurality of serial, analog, digital or frequency input/output fiber optic communication ports on said master controller, one port for each of said I/O subsystems.

5. The industrial control system of claim 1, wherein said fiber-optic cables connecting said fiber optic communication ports at said master controller printed circuit board with fiber optic communication ports on said I/O subsystems distribute serialized I/O signals to said remote I/O boards.
